(19) United States
(12) Patent Application Publication
(10) Pub. No.: US 2016/0019300 A1
(43) Pub. Date: Jan. 21, 2016

(54) Identifying Files for Data Write Operations

(71) Applicant: Microsoft Corporation, Redmond, WA (US)

(72) Inventors: Bryan Jason Dove, Seattle, WA (US); Nuno Jose Pinto Bessa de Melo Cerqueira, Baldock (GB); Tyler Downs, London (GB); Alison M. Reyes, London (GB); Rui Barbosa Martins, London (GB)

(21) Appl. No.: 14/335,558

(22) Filed: Jul. 18, 2014

(51) Int. Cl. G06F 17/30

(52) U.S. Cl. CPC G06F 17/30867; G06F 17/3053; G06F 17/30106; G06F 17/30112

(57) ABSTRACT

Techniques for identifying files for data write operations are described. According to various embodiments, streams of mixed data are sorted based on various criteria and/or filters to generate individual sets of like data. The data sets are buffered in individual data queues in preparation to be written to persistent storage. According to various embodiments, files are requested for storing the data sets. For instance, a file request is submitted that includes write parameters for a data set. Based on the write parameters, a file is identified and selected for storing the data set. An identifier for the file is provided that enables the data set to be written to the file.

### BACKGROUND

Today's connected environment generates massive amounts of data. For instance, cloud-based architectures and services generate data that can be used for various purposes, such as system analytics, diagnostics, and so forth. Handling large amounts of data in a distributed environment presents a number of implementation challenges.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for identifying files for data write operations are described. According to various embodiments, streams of mixed data are sorted based on various criteria and/or filters to generate individual sets of like data. The data sets are buffered in individual data queues in preparation to be written to persistent storage. According to various embodiments, files are requested for storing the data sets. For instance, a file request is submitted that includes write parameters for a data set. Based on the write parameters, a file is identified and selected for storing the data set. An identifier for the file is provided that enables the data set to be written to the file.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for sorting data into data sets in accordance with one or more implementations.

FIG. 3 illustrates an example implementation scenario for obtaining a file for storing data sets in accordance with one or more implementations.

FIG. 4 is a flow diagram that describes steps in a method for sorting data in accordance with one or more embodiments.

FIG. 5 is a flow diagram that describes steps in a method for obtaining a file for storing a data set in accordance with one or more embodiments.

FIG. 6 is a flow diagram that describes steps in a method for identifying a file for a data write operation in accordance with one or more embodiments.

FIG. 7 is a flow diagram that describes steps in a method for selecting a file for a data write operation in accordance with one or more embodiments

FIG. 8 is a flow diagram that describes steps in a method for ascertaining whether a data write operation is successful in accordance with one or more embodiments.

FIG. 9 is a flow diagram that describes steps in a method for selecting a file for a data write operation in accordance with one or more embodiments.

FIG. 10 illustrates an example system and computing device as described with reference to FIG. 1, which are configured to implement embodiments of techniques described herein.

### DETAILED DESCRIPTION

### Overview

Techniques for identifying files for data write operations are described. According to various implementations, streams of mixed data are received that include data of varying types, categories, dates, and so forth. The mixed data is sorted based on various criteria and/or filters to generate individual sets of like data, e.g., individual homogeneous data sets. The data sets are buffered in individual data queues in preparation to be written to persistent storage.

According to various implementations, files are requested for storing the data sets. For instance, a file request is submitted that includes write parameters for a data set, such as a category of data in the data set, a size of the data set, a date parameter for the data set (e.g., a date on which data of the data set was collected), and so forth. Based on the write parameters, a file is identified and selected for storing the data set. An identifier for the file (e.g., a pointer) is provided that enables the data set to be written to the file. Techniques discussed herein are highly scalable to enable many file requests for many different data sets to be submitted and fulfilled, thus increasing the efficiency of data write processes for large collections of data. Further, many different requests for files may occur concurrently, and techniques discussed herein enable such concurrent requests to be fulfilled while avoiding collisions between the different file requests.

According to various implementation, files may be selected from many different storage locations, such as files that maintained at different geographical and physical locations. Further, at least some implementations provide a centralized view of files that are stored across multiple distributed file systems such that file requests may be managed by an entity that maintains state awareness for files that reside on the different file systems. Thus, complexity of managing highly distributed collections of files may be abstracted such that entities that have data to be written may simply request and receive a file without having to negotiate with different individual file systems. Various aspects and implementations that enable these functionalities are detailed below.

In the following discussion, an example environment is first described that is operable to employ techniques described herein. Next, a section entitled “Example Implementation Scenarios” describes some example implementation scenarios for identifying files for data write operations in accordance with one or more implementations. Following this, a section entitled “Example Procedures” describes some example procedures for identifying files for data write operations in accordance with one or more implementations. Finally, a section entitled “Example System and Device” describes an example system and device that are operable to employ techniques discussed herein in accordance with one or more implementations.

Having presented an overview of example implementations in accordance with one or more implementations, consider now an example environment in which example implementations may by employed.

Example Environment

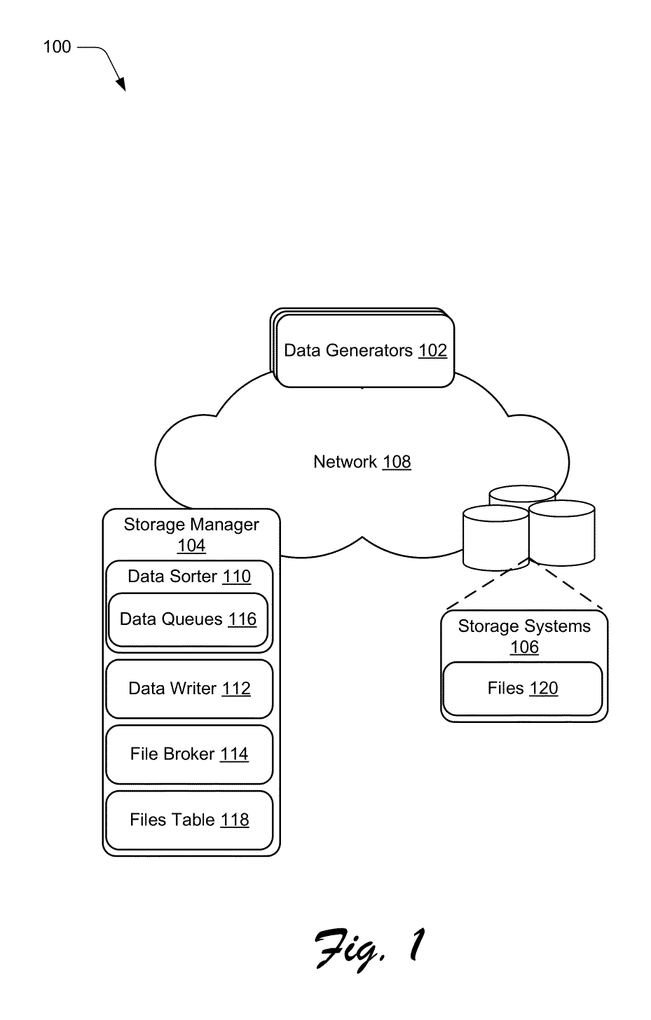

FIG. 1 is an illustration of an environment 100 in an example implementation that is operable to employ techniques for identifying files for data write operations described herein. Generally, the environment 100 includes various devices, services, and functionalities that can be employed to implement techniques discussed herein. The environment 100 includes data generators 102, which are representative of functionalities that generate various types of data. In at least some implementations, the data generators 102 represent discrete devices, such as a traditional computer (e.g., a desktop personal computer, laptop computer, and so on), a mobile station, an entertainment appliance, a smartphone, a netbook, a game console, a handheld device (e.g., a tablet), a wearable computing device, and so forth. The data generators 102 may also include various services and processes that generate data, such as services running in data centers, distributed processes, functionalities that collect environmental data, and so forth.

The environment 100 further includes a storage manager 104, which is representative of functionality to receive and process data generated by the data generators 102, and to enable processed data to be stored by storage systems 106. In at least some implementations, the storage manager 104 receives data from the data generators 102 via a network 108. Generally, the network 108 is representative of infrastructure and components that provide connectivity for data transmission among various entities. The network 108 may be implemented in various ways, such as via combinations of wired and wireless networks, local area networks (LANs), wide area networks (WANs), the Internet, and so forth.

The storage systems 106 may be implemented in various ways. For instance, different instances of the storage systems 106 may be distributed over various different physical and/or geographic locations. Individual storage systems 106, for example, may maintain instances of the storage manager 104. Thus, although a single storage manager 104 is illustrated, it is to be appreciated that multiple instances of the storage manager 104 may be employed by different entities and/or at different locations. Alternatively or additionally, the storage manager 104 may be implemented as a centralized service that can serve multiple different distributed storage systems 106. In at least some implementations, the storage manager 104 and/or the storage systems 106 may be implemented via data centers, enterprise facilities, cloud-based storage services, and so forth.

The storage manager 104 includes various components for implementing techniques for identifying files for data write operations discussed herein, including a data sorter 110, a data writer 112, and a file broker 114. The data sorter 110 is representative of functionality for sorting data received from the data generators 102, and placing sorted data into different data queues 116. Data may be sorted based on a variety of different criteria, examples of which are discussed below. Generally, the data queues 116 are representative of functionalities for temporary storage of data of different categories and/or types. For instance, individual data queues 116 may each be associated with a different category and/or type of data. Thus, in at least some implementations, the data sorter 110 may be considered a multiplexer that takes a heterogeneous stream of data and sorts it into individual homogeneous data sets and/or data streams.

The data writer 112 is representative of functionality to retrieve data from the data queues 116 and cause the data to be stored to a physical storage location. For instance, the data writer 112 requests a storage location for storing data from a particular data queue 116 from the file broker 114. According to implementations discussed herein, the file broker 114 accesses a files table 118, which includes status information for files 120 stored by the storage systems 106. In at least some implementations, the files table 118 is implemented as a non-structured query language (SQL) storage structure, e.g., a NoSQL and/or not only SQL storage structure.

According to various implementations, the files table 118 identifies discrete files 120 and status information for the files 120. For example, the files table 118 indicates memory size information for individual files, such as a current size of a file (e.g., in bytes), a maximum memory size for a file, how much available storage space a file has. The files table 118 may also indicate whether a file is available to be written to (e.g., whether a file is currently in use and/or locked), whether a file has timed-out, and so forth. The files table 118 also includes descriptive information for individual files, such as types and/or categories of data stored in individual files. The files table may also include identification and/or access information for individual files, such as pointers that may be used to access individual files.

In response to the request from the data writer 112, the file broker 114 identifies a candidate file from the files 120 that is eligible for receiving the data from a data queue 116. The file broker 114 notifies the data writer 112 of the file such that the data writer 112 may write the data to the file. Further details of this process and related processes are discussed below.

While the various functionalities of the storage manager 104 are illustrated as being integrated, it is to be appreciated that at least some of the functionalities may be implemented at different physical locations and/or by different entities. According to various implementations, the different entities illustrated in the environment 100 may be implemented via hardware, software, and/or combinations thereof.

Having described attributes of an example environment in which the techniques described herein may operate, consider now some example implementation scenarios for identifying files for data write operations in accordance with one or more implementations.

Example Implementation Scenarios

The following section describes some example implementation scenarios for identifying files for data write operations in accordance with one or more implementations. The example implementation scenarios may be implemented in the environment 100 discussed above, and/or any other suitable environment.

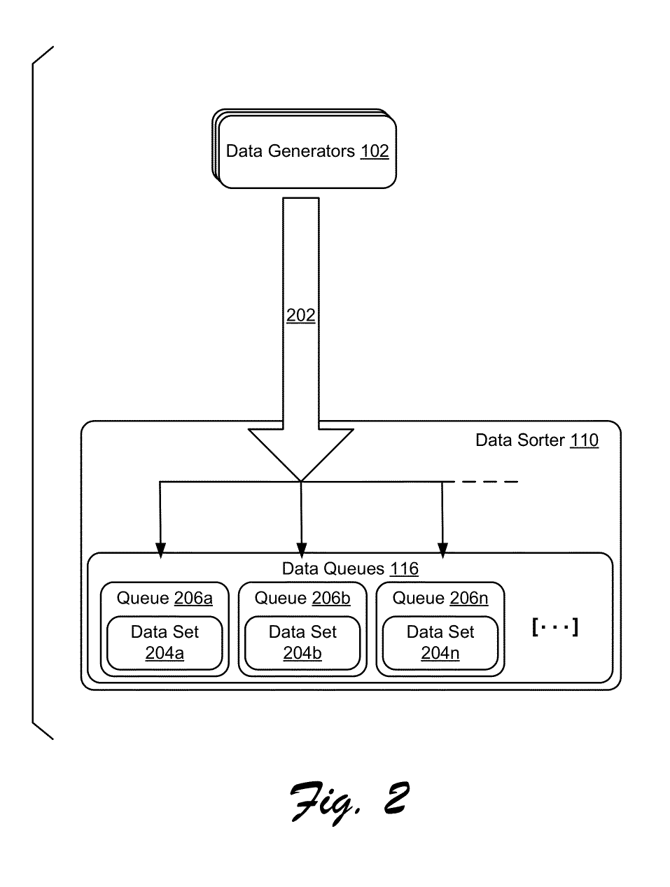

FIG. 2 illustrates an example implementation scenario 200 for sorting data into data sets in accordance with one or more implementations. The scenario 200 includes various entities and components introduced above with reference to the environment 100.

In the scenario 200, the data sorter 110 receives a data stream 202 from the data generators 102. The data stream 202 may include any suitable type of data. In at least some implementations, the data stream 202 includes telemetry data collected from various devices, systems, sensors, and/or other data-generating mechanism or process. For purposes of discussion herein, the data stream 202 represents telemetry data (e.g., metadata) collected from communication events between different user devices, such as Voice over Internet Protocol (VoIP) calls, video calls, chat sessions, unified communications (UC) sessions, and so forth. This is not to be construed as limiting, however, and the data stream 202 may include any type of data.

Further to the scenario 200, the data stream 202 represents a heterogeneous collection of data that includes data of a wide variety of different types and categories. Accordingly, the data sorter 110 parses the data stream 202 into a data set 204a, a data set 204b, and a data set 204n. Generally, the data sets 204a-204n correspond to different categories of data with different attributes. The data sorter 110 stores (e.g., buffers) the data sets 204a-204n in respective data queues 116. In this particular example, the data set 204a is stored in a data queue 206a, the data set 204b is stored in a data queue 206b, and the data set 204n is stored in a data queue 206n. Generally, the data queues 204a-204n represent temporary data stores (e.g., buffers) that are individually populated with a particular category of data extracted from the data stream 202.

With reference to communication events, for instance, the data sets 204a-204n each represent different telemetry data collected from many different individual communication sessions. Examples of such telemetry data include event type (e.g., voice, video, messaging, and so forth), event date, event duration, how individual events were initiated, event quality attributes (e.g., packet drop percentage, whether an event was dropped, user feedback regarding event quality, and so forth), features that were utilized during a communication event, and so on. These particular categories of data are presented for purpose of example only, and a wide variety of different types and categories of data may be recognized and/or defined in accordance with various implementations.

Although the scenario 200 is illustrated with reference to a single data stream 202, it is to be appreciated that the data stream 202 may represent many different discrete data streams that are received from many different data generators 102 and parsed into their constituent data categories. With reference to communication events, for instance, the data stream 202 may represent telemetry data from millions or more different discrete communication events.

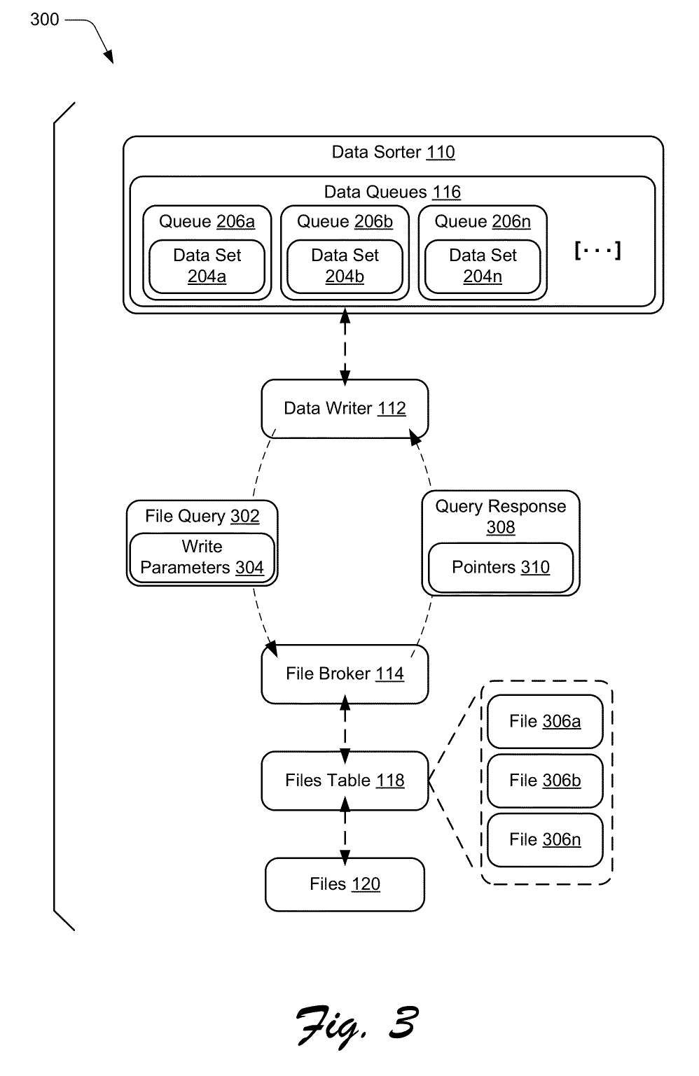

FIG. 3 illustrates an example implementation scenario 300 for obtaining a file for storing data sets in accordance with one or more implementations. The scenario 300 includes various entities and components introduced above with reference to the environment 100. In at least some implementations, the scenario 300 is an example continuation of the scenario 200.

In the scenario 300, the data writer 112 ascertains that the data queues 206a-206n are populated with data sets 204a-204n that are to be written to persistent storage. The data writer 112, for instance, queries the data sorter 110 to ascertain whether the data queues 116 have data that is to be written to storage. Alternatively or additionally, the data sorter 110 notifies the data writer 112 that the data queues 116 have data sets 204a-204n that are to be written to storage.

In response to ascertaining that the data queues 116 include data to be stored, the data writer 112 communicates a file query 302 to the file broker 114. According to various implementations, the file query 302 includes write parameters 304, which specify information about the data sets 204a-204n, such as categories for the data, date(s) on which the data was collected, amount of data (e.g., in bytes), and so forth. The file broker 114 receives the file query 302 and inspects the request to determine the write parameters.

Based on the write parameters 304, the file broker 114 identifies a file 306a, a file 306b, and a file 306n of the files 120 from the files table 118 that correspond to the write parameters 304. The files 306a-306n, for instance, correspond to respective data categories, dates, and so forth, for the data sets 204a-204n, and have sufficient available storage space for the data of the data sets 204a-204n. In at least some implementations, the files 306a-306n are existing files that have previously been written to with data of the same or similar categories for the data sets 204a-204n. Alternatively or additionally, if an existing file 120 is not available for a particular data set (e.g., is not identified in the files table 118), a new file can be created for the data set. A detailed procedure for selecting candidate files is discussed below.

Further to the scenario 300, the file broker 114 then places a lock on the files 306a-306n such that other entities (e.g., other instances of the file broker 114) do not access the files 306a-306n and/or identify the files 306a-306n as being available for data writes. According to various implementations, the file broker 114 updates the files table 118 to indicate that the files 306a-306n are locked, e.g., that the files 306a-306n are not available and/or are currently in use. The file broker 114 generates a query response 308 that includes pointers 310 to the files 306a-306n. Generally, the pointers 310 are representative of data that identifies the files 306a-306n and/or that identifies respective locations of the files 306a-306n among the files 120.

The file broker 114 communicates the query response 308 to the data writer 112. The data writer 112 parses the query response 308 to obtain the pointers 310. The data writer 112 uses the pointers 310 to write the data sets 204a-204n to respective files of the files 308a-308n.

According to various implementations, after the data writer 112 is finished writing the data sets 204a-204n to the respective files 308a-308n, the data writer 112 notifies the file broker 114 that it is finished writing to the files 306a-306n. In response, the file broker 114 can verify that the data sets 204a-204n were successfully written to the respective files 306a-306n. The file broker 114, for instance, ascertains whether any write errors occurred during the write operations to the files 306a-306n. If an error occurred such that a data set 204a-204n was not successfully written to a file 306a-306n, the file broker 114 notifies the data writer 112 that the data sets 204a-204n were not successfully stored. In at least some implementations, in response to the failure of the data write, the scenario 300 may be performed again to select new files and to write the data sets 204a-204n to the new files.

If the file broker 114 ascertains that the data writes to the files 306a-306n were successful, the file broker 114 notifies the data writer 112 that the write operations were successful. The data writer 112 may then perform other data write operations, such as starting with the scenario 200 with other data sets from the data queues 116. The file broker 114 may also update the files table 118 to indicate that the candidate files 120 are now available to be written to, e.g., to unlock the files 306a-306n. The file broker 114 may also update the files table 118 to indicate an amount of storage space available in the respective files 306a-306n. In at least some implementations, for instance, at least some of the files 120 may have a maximum size threshold. Thus, if a file write operation would cause a file 120 to exceed its maximum size threshold, the file 120 may be indicated as not being a candidate for that write operation.

According to various implementations, many instances of the scenarios 200 and 300 may be performed, such as concurrently across many different storage locations to sort many different heterogeneous data streams into data sets for persistent storage according to techniques discussed herein. Further, the scenarios 200 and 300 represent dynamic processes that may be repeatedly (e.g., continually) performed over a period of time to process new data streams that are generated.

Having discussed an example implementation scenario, consider now a discussion of some example procedures in accordance with one or more implementations.

Example Procedures

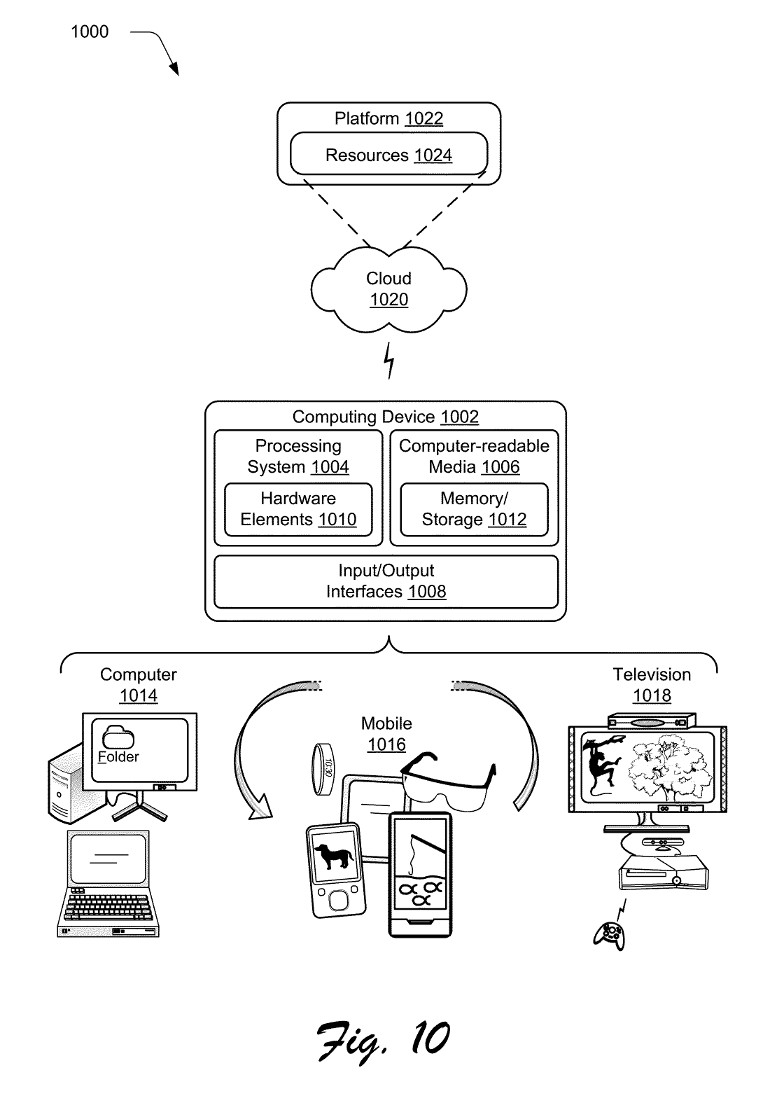

The following discussion describes some example procedures for identifying files for data write operations in accordance with one or more implementations. The example procedures may be employed in the environment 100 of FIG. 1, the system 1000 of FIG. 10, and/or any other suitable environment. Further, the example procedures may represent implementations of aspects the example implementation scenarios discussed above. In at least some implementations, steps described for the various procedures can be implemented automatically and independent of user interaction.

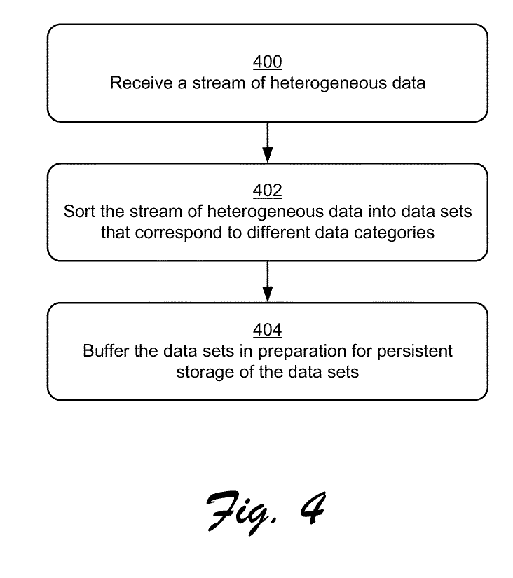

FIG. 4 is a flow diagram that describes steps in a method in accordance with one or more implementations. The method describes an example procedure for sorting data in accordance with one or more implementations.

Step 400 receives a stream of heterogeneous data. The data sorter 110, for instance, receives the data stream 202 from the data generators 102.

Step 402 sorts the stream of heterogeneous data into data sets that correspond to different data categories. The heterogeneous data, for instance, can be filtered based on various filtering criteria into different sets of homogeneous and/or semi-homogeneous data. Examples of different criteria and/or categories that can be utilized to sort data are discussed above. In at least some implementations, sorting does not include a full ordering of sorted data, but may simply be implemented via bucketing of data of particular categories with other similar data.

Step 404 buffers the data sets in preparation for persistent storage of the data sets. The data sets can be stored in respective data queues, examples of which are discussed above.

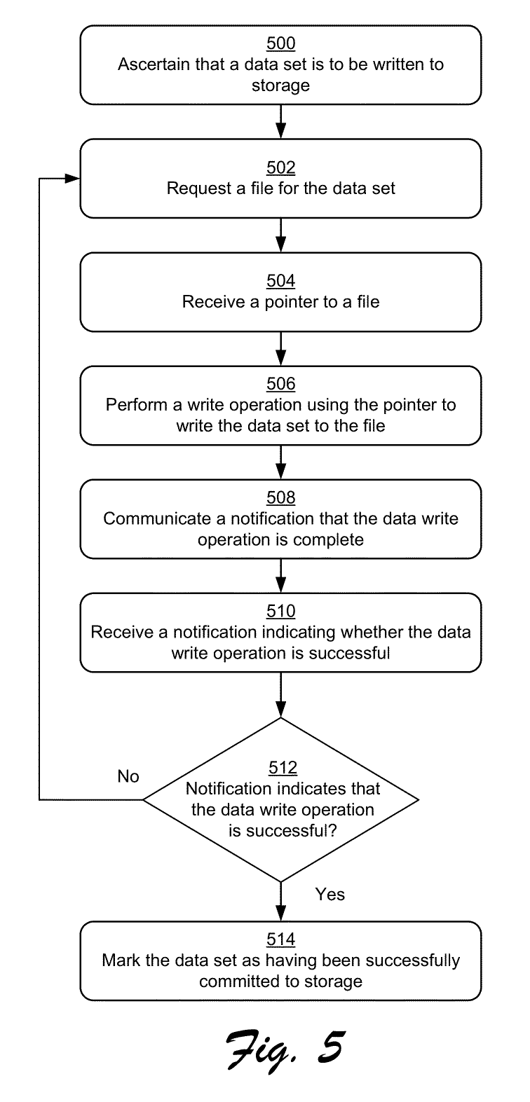

FIG. 5 is a flow diagram that describes steps in a method in accordance with one or more implementations. The method describes an example procedure for obtaining a file for storing a data set in accordance with one or more implementations. In at least some implementations, the method describes an example extension of the method described above with regard to FIG. 4.

Step 500 ascertains that a data set is to be written to storage. The data writer 112, for instance, ascertains that a data queue 116 includes a data set that is to be written to persistent storage. In at least some implementations, a process for writing a data set from a data queue 116 to storage can be initiated in response to the data set exceeding a particular size threshold, e.g., in bytes. For instance, the method described above with reference to FIG. 4 may be performed to append data the data queues 116 until a particular data queue 116 exceeds a threshold size. In response to the data queue exceeding the threshold size, a process to write data from the data queue to persistent storage (e.g., to the files 120) can be initiated.

Step 502 requests a file for the data set. The data writer 112, for instance, communicates the file query 302 with the write parameters 304 for the data set to the file broker 114.

Step 504 receives a pointer to a file. For example, the data writer 112 receive the query response 308 that includes a pointer 310 that points to the file. The pointer 310, for instance, identifies a discrete instance of file, such as based on a memory address, a link to a file, and so forth. In at least some implementations, the pointer 310 indicates a location in the file where the data write operation is to begin, such as an offset value from the beginning of the file.

Step 506 performs a write operation using the pointer to write the data set to the file. The data writer 112, for instance, writes the data set to a storage location identified by the pointer 310.

Step 508 communicates a notification that the data write operation is complete. For example, the data writer 112 notifies the file broker 114 that the data writer 112 has finished writing the data set to the file.

Step 510 receives a notification indicating whether the data write operation is successful. The data writer 112, for instance, receives a notification from the file broker 114 indicating either that the data write operation was successful, or that the data write operation failed. As discussed elsewhere herein, a data write operation may fail if an error occurs as part of the operation.

Step 512 ascertains whether the notification indicates that the data write operation is successful. If the notification indicates that the data write operation is successful (“Yes”), step 514 marks the data set as having been successfully committed to storage. For example, the data writer 112 may notify the data sorter 110 that a data queue 116 in which the data set is stored may be used to store other data, e.g., that the data set may be overwritten with other data.

If the notification indicates that the data write operation is not successful (“No”), the process returns to step 502 to initiate a new data write operation for the data set. In at least some implementations, the method may be performed multiple times until a notification of a successful data write operation for the data set is received.

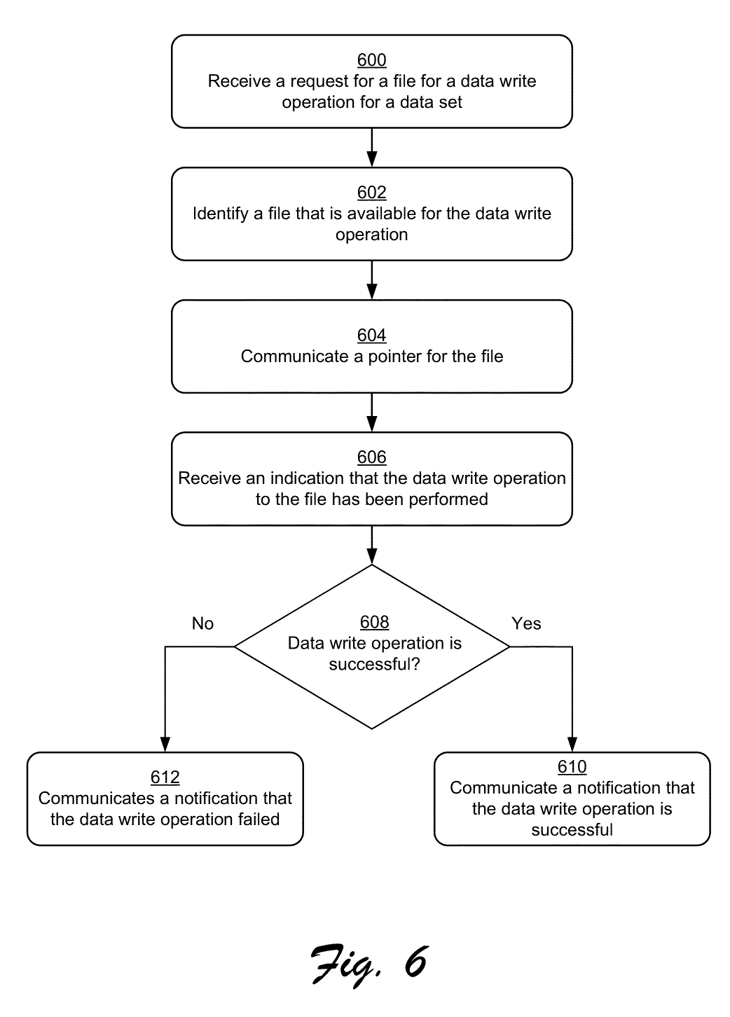

FIG. 6 is a flow diagram that describes steps in a method in accordance with one or more implementations. The method describes an example procedure for identifying a file for a data write operation in accordance with one or more implementations.

Step 600 receives a request for a file for a data write operation for a data set. The request, for instance, includes parameters for the data write operation, such as a category of data for the write operation, an amount (e.g., size in bytes) of data to be written, various descriptive attributes of the data to be written, and so forth. The request, for example, may be implemented via the file query 302 discussed above with reference to FIG. 3. For instance, the request may be a request for a file to store a buffered data set generated according to the method described above with reference to FIG. 4.

Step 602 identifies a file that is available for the data write operation. The file broker 114, for instance, scans and index of the files table 118 for files 120 that are candidates to receive the data write operation. In at least some implementations, the file broker 114 matches parameters from the request to parameters of available files 120, such as files with data of the same or similar category as data associated with the data write operation. The file broker 114, for instance, matches write parameters 304 from the file query 302 to attributes of different files 120 to identify a file that matches one or more of the write parameters 304. A detailed procedure for selecting a file for a data write operation is discussed below.

Step 604 communicates a pointer for the file. The file broker 114, for instance, communicates the query response 308 to the data writer 112 that includes a pointer 310 to a candidate file. The pointer 310 may include various information that enables the candidate file to be accessed, such as a memory address for the file, a link to the file (e.g., a uniform resource indicator (URI) for the file, a uniform resource locator (URL) for the file, and so on), and so forth.

Step 606 receives an indication that the data write operation to the file has been performed. For example, the file broker 114 receives a notification from the data writer 112 that the data write operation is complete.

Step 608 ascertains whether the data write operation is successful. The file broker 114, for instance, checks the file to ascertain whether any errors occurred as part of the data write operation, such as data corruption, file corruption, a data write failure, and so forth. An example way of determining whether a data write operation is successful is detailed below.

If the data write operation is successful (“Yes”), step 610 communicates a notification that the data write operation is successful. For example, the file broker 114 communicates a notification to the data writer 112 that the data write operation is successful. In at least some implementations, a data queue 116 that stores data used for the data write operation may be cleared in response to the notification of the successful data write operation, such as to free buffer space for additional data sets to be written to storage.

If the data write operation is not successful (“No”), step 612 communicates a notification that the data write operation failed. For instance, if the file broker 114 determines that an error occurred as part of the data write operation, the file broker 114 notifies the data writer 112 that the data write operation failed. In at least some implementations, the data writer 112 may initiate another data write operation for the data set in response to the notification of the failure, such as discussed above with reference to FIG. 5.

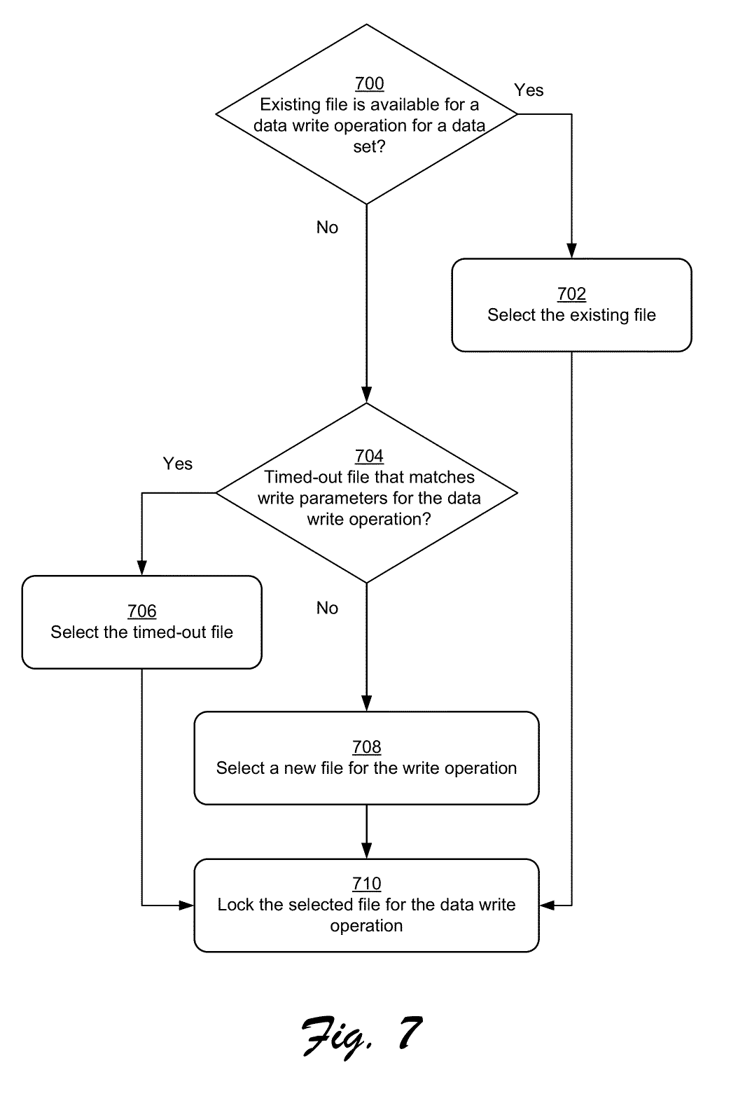

FIG. 7 is a flow diagram that describes steps in a method in accordance with one or more implementations. The method describes an example procedure for selecting a file for a data write operation in accordance with one or more implementations. In at least some implementations, the method describes detailed ways of implementing various aspects of the method described above with reference to FIG. 6.

Step 700 ascertains whether an existing file is available for a data write operation for a data set. The file broker 114, for instance, ascertains whether the files table 118 includes a record for a file 120 that matches one or more write parameters for the data set and has sufficient available storage space to store the data set. Examples of different write parameters for a data set are discussed above.

If an existing file is available for the data write operation (“Yes”), step 702 selects the existing file. For example, the file broker 114 selects an existing file identified in the files table 118 as matching write parameters for the data set, that has sufficient storage space to store the data set, and that is available to be written to, e.g., is not locked by another process.

If an existing file is not available for the data write operation (“No”), step 704 ascertains whether a timed-out file is identified that matches write parameters for the data write operation. In at least some implementations, a timed-out file refers to a file that was locked for a different data write operation, but that has exceeded its allotted time. For instance, when a file is selected for a data write operation, the file is locked such that other processes cannot access the file, such as for data read/write operations. As part of locking a file, a lock timer for the file is started. Generally, the lock timer corresponds to an amount of time that the file is leased to an associated process (e.g., the data writer 112) for performing a data write operation to the file. Any suitable amount of time may be specified for a lock timer, such as in a discrete number of minutes, seconds, and so forth.

When the lock timer expires, the file may be indicated as timed-out such that other processes may interact with the file, such as for data read/write operations. For instance, a timed-out file may be obtained and locked for a different data write operation, even if the original timed-out data write operation is not complete. In an event that a data write operation times-out before it is complete and another process obtains the file, the data write operation may be failed such that it may be reinitiated (e.g., reattempted) with a different file.

According to various implementations, the files table 118 can track lock timer status for locked files. Thus, when a lock timer for a file expires, the file can be marked in the files table 118 as timed-out such that it is available to be accessed by other processes, such as other data write operations.

Returning to the method, if a timed-out file is identified that matches write parameters for the file (“Yes”), step 706 selects the timed-out file. If a timed-out file is not identified that matches write parameters for the file (“No”), step 708 selects a new file for the write operation. For instance, the file broker 114 communicates with a particular storage systems 106 and causes a new file 120 to be created that corresponds to write parameters for the data write operation.

Step 710 locks the selected file for the data write operation. The file broker 114, for example, marks the file in the files table 118 as locked for the particular data write operation, such that only the data write operation is permitted to access the file.

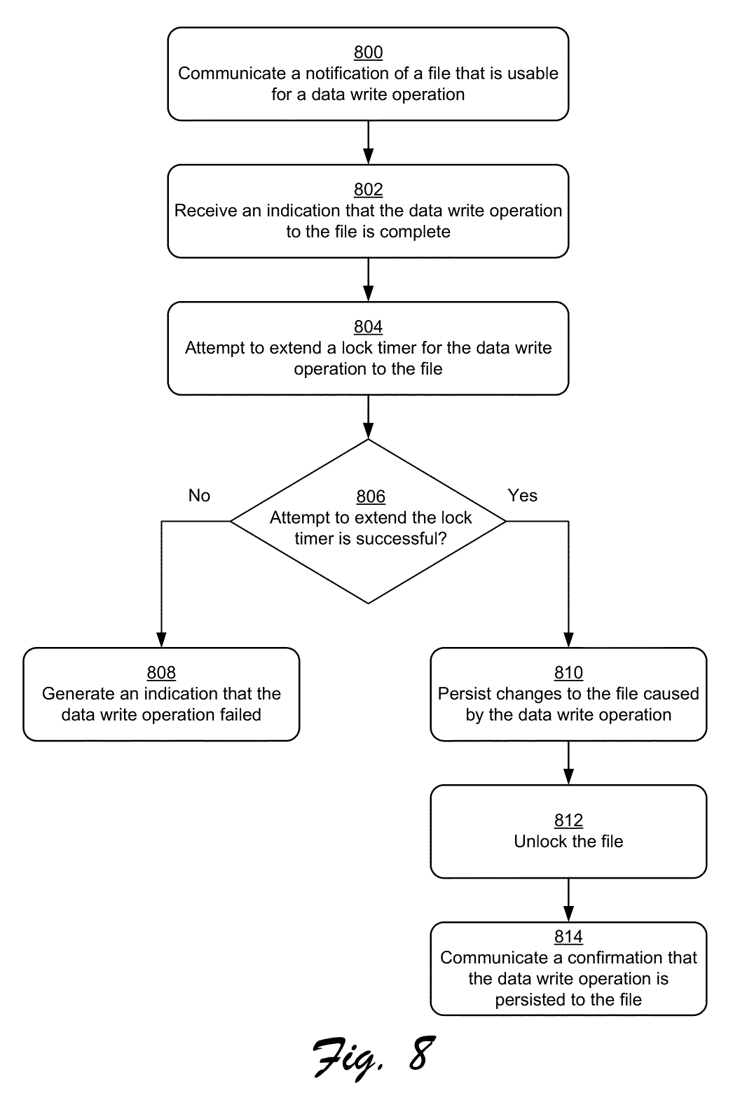

FIG. 8 is a flow diagram that describes steps in a method in accordance with one or more implementations. The method describes an example procedure for ascertaining whether a data write operation is successful in accordance with one or more implementations. In at least some implementations, the method describes an extension and/or continuation of the method described above with reference to FIG. 7.

Step 800 communicates a notification of a file that is usable for a data write operation. The file broker 114, for instance, communicates the query response 308 with the pointer 310 to the data writer 112. In at least some implementations, the file corresponds to a file selected according to the method discussed above with regard to FIG. 7.

Step 802 receives an indication that the data write operation to the file is complete. For example, the file broker 114 receives a notification that the data writer 112 is finished writing data to the file.

Step 804 attempts to extend a lock timer for the data write operation to the file. The file broker 114, for instance, interacts with the files table 118 to attempt to extend a time remaining on a lock timer for the date write operation. In at least some implementations, extending a lock timer involves adding additional time to a lock timer that is currently elapsing, e.g., that has not expired. Extending a lock timer may also include refreshing or restarting a lock timer that has expired. According to various implementations, a lock timer may be extended by a pre-specified amount of time, e.g., in seconds, minutes, and so on. Alternatively or additionally, an amount of time by which a lock timer is extended may be dynamically determined, such as based on various data write attributes. Examples of such data write attributes include an amount of data involved in the data write operation, a type of data, a priority level for the data, and so forth.

Step 806 ascertains whether the attempt to extend the lock timer is successful. If the attempt to extend the lock timer is not successful (“No”), step 808 generates an indication that the data write operation failed. In at least some implementations, an attempt to extend a lock timer may fail if the lock timer expires and another process locks the file, such as for a data write and/or read operation. For instance, another process may “steal” a file that has timed-out during a data write operation. As referenced above, a file whose lock timer expires may be indicated in the files table 118 as a timed-out file such that other processes (e.g., other data write operations) may lock the file for use. See, for example, step 704 discussed above with reference to FIG. 7.

According to various implementations, the file broker 114 may notify the data writer 112 that the data write operation failed. Thus, data involved in the data write operation may be marked for a subsequent data write operation. Further, portions of a file that were written to as part of the failed data write operation may be indicated as available for subsequent data writes. For instance, the data that was written to the file as part of the failed data write operation is not subject to a commit operation that causes the data to become persistent in the file. Thus, the data may be written over with other data and may not be visible, such as for a read operation.

Returning to the method, if the attempt to extend the lock timer is successful (“Yes”), step 810 persists changes to the file caused by the data write operation. The file broker 114, for instance, extends the lock timer by a discrete amount of time, during which the file broker 114 causes a commit operation to be performed on the data such that the data is persisted to the file. According to various implementations, this enables the data to be visible to other processes, such that the data can be read and/or processed in various ways.

Step 812 unlocks the file. For example, the file broker 114 marks the file in the files table 118 as available for other data write operations. In at least some implementations, the file broker 114 may update status information for the file in the files table 118, such as an amount of storage space remaining in the file, a category of data stored in the file, and so forth.

Step 814 communicates a confirmation that the data write operation is persisted to the file. The file broker 114, for instance, communicates a notification to the data writer 112 that data involved in the data write operation is persisted (e.g., committed) to the file.

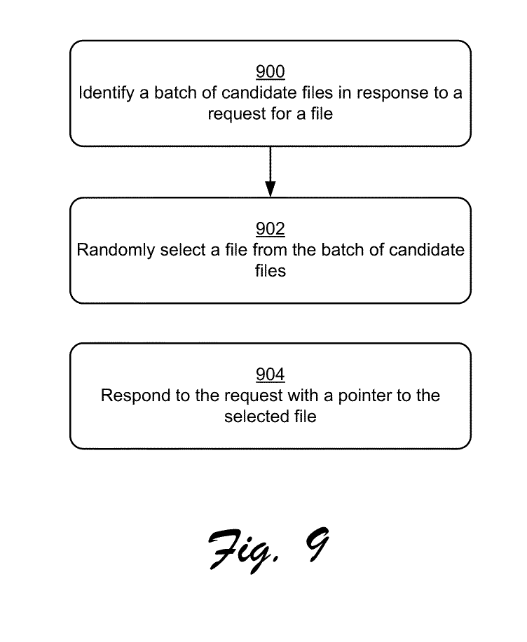

FIG. 9 is a flow diagram that describes steps in a method in accordance with one or more implementations. The method describes an example procedure for selecting a file for a data write operation in accordance with one or more implementations. In at least some implementations, the method describes a detailed implementation of step 602 discussed with reference to FIG. 6, and/or an implementation detail for selecting a file according to the method discussed with reference to FIG. 7.

Step 900 identifies a batch of candidate files in response to a request for a file. The file broker 114, for instance, identifies multiple available (e.g., unlocked) files from the files table 118 that match write parameters associated with the file request. Alternatively or additionally, the file broker 114 may identify timed-out files from the files table 118 that match write parameters associated with the file request. According to various implementations, the batch of files may include available files, timed-out files, or a combination of both.

Step 902 randomly selects a file from the batch of candidate files. For example, the file broker 114 may employ any suitable random selection algorithm to select an instance of a file from the batch of candidate files. In at least some implementations, random file selections aids in avoiding file collision with other processes, e.g., other file brokers 114 that are identifying files for other data write operations.

Step 904 responds to the request with a pointer to the selected file. The file broker 114, for instance, communicates the pointer to the data writer 112 for use as part of a data write operation. Examples of different file pointers are discussed above.

While the various examples presented above are discussed with reference to individual data write operations, it is to be appreciated that the techniques discussed herein are scaleable to enable numerous data write operations to be initiated and managed (e.g., concurrently) for numerous different data sets.

Having discussed some example procedures, consider now a discussion of an example system and device in accordance with one or more implementations.

Example System and Device

FIG. 10 illustrates an example system generally at 1000 that includes an example computing device 1002 that is representative of one or more computing systems and/or devices that may implement various techniques described herein. For example, the client device 102, the network controller 118, and/or the remote configuration service 128 discussed above can be embodied as the computing device 1002. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more Input/Output (I/O) Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “service,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1010 and computer-readable media 1006 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules that are executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, a wearable device, portable music player, portable gaming device, a tablet computer, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. For example, functionalities discussed with reference to the client device 102, the network controller 118, and/or the remote configuration service 128 may be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi™ network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Techniques for identifying files for data write operations are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

What is claimed is:

1. A system comprising:
at least one processor; and
one or more computer-readable storage media including instructions stored thereon that, responsive to execution by the at least one processor, cause the system perform operations including:
receiving a request for a file for a data write operation for a data set, the request identifying a category of data included in the data set;
identifying a file that is available for the data write operation by scanning a collection of available files to ascertain whether at least one file of the available files matches the category of data indicated by the request;
communicating a pointer to the file, the pointer being usable to write the data set to the file;
receiving an indication that the data write operation to the file has been performed;
ascertaining whether the data write operation to the file is successful; and
communicating a notification indicating whether the data write operation is successful.

2. A system as recited in claim 1, wherein the collection of available files includes files from multiple different storage locations.

3. A system as recited in claim 1, wherein the operations further include, responsive to said identifying, locking the identified file to prevent a different data write operation from accessing the file.

4. A system as recited in claim 1, wherein the request further includes a size of the data set, and wherein said identifying further comprises identifying the file based on the file having sufficient storage space to store the data set.

5. A system as recited in claim 1, wherein said identifying comprises.
in an event that the collection of available files includes an existing file that is available for the data write operation, selecting the existing file as the file that is available for the data write operation;
in an event that the collection of available files does not include an existing file that is available for the data write operation, ascertaining whether a timed-out filed is identified that matches the category of data indicated by the request;
in an event that a timed-out filed is identified that matches the category of data indicated by the request, selecting the timed-out file as the file that is available for the data write operation; and
in an event that a timed-out filed is not identified that matches the category of data indicated by the request, causing a new file to be created for the data write operation.

6. A system as recited in claim 1, wherein said identifying comprises:
identifying a batch of candidate files that match the category of data indicated by the request from the collection of available files; and
randomly selecting the file from the batch of candidate files.

7. A system as recited in claim 1, wherein said ascertaining comprises:
attempting to extend a lock timer for the data write operation to the file;
in an event that said attempting fails, ascertaining that the data write operation has failed; or
in an event that said attempting is successful, persisting changes to the file caused by the data write operation.

8. A system as recited in claim 7, wherein said attempting causes the lock timer to be extended by a discrete amount of time during which the changes to the file caused by the data write operation are persisted.

9. A system as recited in claim 7, wherein the operations further include, responsive to ascertaining that the data write operation has failed, communicating the notification to indicate that the data write operation failed.

10. A system as recited in claim 1, wherein the operations further include, responsive to ascertaining that the data write operation is successful:
persisting changes to the file caused by the data write operation; and
communicating the notification to indicate that the data write operation is persisted.

11. A computer-implemented method, comprising:
identifying a batch of candidate files in response to a request for a file for storing a data set, including identifying the candidate files based on write parameters for the data set specified by the request;
randomly selecting a file from the batch of candidate files; and
responding to the request with a pointer to the selected file.

12. A method as described in claim 11, wherein the write parameters indicate a category of data included in the data set.

13. A method as described in claim 11, wherein the write parameters indicate a date on which data of the data set was collected.

14. A method as described in claim 11, wherein the write parameters indicate a size of the data set.

15. A method as described in claim 11, wherein the batch of candidate files includes available files, timed-out files, or a combination of both.

16. A method as described in claim 11, wherein said identifying comprises matching one or more of the write parameters to attributes of data included in the candidate files.

17. A computer-implemented method, comprising:
ascertaining that a data set is to be written to storage;
requesting a file for storing the data set, including communicating a file query that includes a category of data included in the data set and a size of the data set;
receiving a pointer to a file in response to said requesting; and
performing a data write operation using the pointer to write the data set to the file.

18. A method as described in claim 17, wherein said ascertaining comprises ascertaining that the data set is stored in a data queue that buffers data that corresponds to the category of data.

19. A method as described in claim 17, wherein the file query further includes one or more of a date parameter for the data set or a size of the data set.

20. A method as described in claim 17, further comprising:
communicating a notification that the data write operation is complete;
receiving a notification indicating whether the data write operation is successful;
in an event that the notification indicates that the data write operation is successful, marking the data set as having been successfully committed to storage; or
in an event that the notification indicates that the data write operation is not successful, initiating a new data write operation for the data set.
